(19) United States
(12) Patent Application Publication
(10) Pub. No.: US 2014/0160264 A1
(43) Pub. Date: Jun. 12, 2014

(54) AUGMENTED FIELD OF VIEW IMAGING SYSTEM

(71) Applicant: THE JOHNS HOPKINS UNIVERSITY, Baltimore, MD (US)

(72) Inventors: Russell H. Taylor, Severna Park, MD (US); Balazs Peter Vagvolgyi, Baltimore, MD (US); Gregory D. Hager, Baltimore, MD (US); Richa Rogerio, Baltimore, MD (US)

(73) Assignee: The Johns Hopkins University, Baltimore, MD (US)

(21) Appl. No.: 13/710,085

(22) Filed: Dec. 10, 2012

(51) Int. Cl. G06T 19/00

(52) U.S. Cl. CPC G06T 19/006
USPC 348/79

(57) ABSTRACT

An augmented field of view imaging system includes a microscope, an image sensor system arranged to receive images of a plurality of fields of view from the microscope as the microscope is moved across an object being viewed and to provide corresponding image signals, an image processing and data storage system configured to communicate with the image sensor system to receive the image signals and to provide augmented image signals, and at least one of an image injection system or an image display system configured to communicate with the image processing and data storage system to receive the augmented image signals and display an augmented field of view image. The image processing and data storage system is configured to track the plurality of fields of view in real time and register the plurality of fields of view to calculate a mosaic image. The augmented image signals from the image processing and data storage system provide the augmented image such that a live field of view from the microscope is composited with the mosaic image.

### CROSS-REFERENCE OF RELATED APPLICATION

This invention was made with Government support of Grant No. 1 R01 EB 007969, awarded by the Department of Health and Human Services, The National Institutes of Health (NIH). The U.S. Government has certain rights in this invention.

### BACKGROUND

1. Field of Invention

The field of the currently claimed embodiments of this invention relates to imaging systems, and more particularly to augmented field of view imaging systems.

2. Discussion of Related Art

Retinal surgery is considered one of the most demanding types of surgical intervention. Difficulties related to this type of surgery arise from several factors such as the difficult visualization of surgical targets, poor ergonomics, lack of tactile feedback, complex anatomy, and high accuracy requirements. Specifically regarding intra-operative visualization, surgeons face limitations in field and clarity of view, depth perception and illumination which hinder their ability to identify and localize surgical targets. These limitations result in long operating times and risks of surgical error.

A number of solutions for aiding surgeons during retinal surgery have been proposed. These include robotic assistants for improving surgical accuracy and mitigating the impact of physiological hand tremor [1], micro-robots for drug delivery [2] and sensing instruments for intra-operative data acquisition [3] have been proposed. In regard to the limitations in visualization, systems for intra-operative view expansion and information overlay have been developed in [4, 5]. In such systems, a mosaic of the retina is created intra-operatively and pre-operative surgical planning and data (e.g. Fundus images) are displayed during surgery for improved guidance.

Although several solutions have been proposed in the field of minimally invasive surgery and functional imaging [6, 7], retinal surgery imposes additional challenges such as highly variable illumination (the illumination source is manually manipulated inside the eye), partial and full occlusions, focus blur due to narrow depth of field and distortions caused by the flexible eye lens. Although the systems proposed in [4, 5] suggest potential improvements in surgical guidance, they lack robustness to such disturbances.

### REFERENCES FOR BACKGROUND SECTION

1. Mitchell, B., Koo, J., Iordachita, I., Kazanzides, P., Kapoor, A., Handa, J., Taylor, R., Hager, G.: Development and application of a new steady-hand manipulator for retinal surgery. In: ICRA, Rome, Italy (2007) 623-629
2. Bergeles, C., Kummer, M. P., Kratochvil, B. E., Framme, C., Nelson, B. J.: Steerable intravitreal inserts for drug delivery: in vitro and ex vivo mobility experiments. In: MICCAI. (LNCS), Toronto, Canada, Springer (2011) 33-40
3. Balicki, M., Han, J., Iordachita, I., Gehlbach, P., Handa, J., Taylor, R., Kang, J.: Single fiber optical coherence tomography microsurgical instruments for computer and robot-assisted retinal surgery. In: MICCAI. Volume 5761 of (LNCS)., London, UK, Springer (2009) 108-115
4. Fleming, I., Voros, S., Vagvolgyi, B., Pezzementi, Z., Handa, J., Taylor, R., Hager, G.: Intraoperative visualization of anatomical targets in retinal surgery. In: IEEE Workshop on Applications of Computer Vision (WACV'08). (2008) 1-6
5. Seshamani, S., Lau, W., Hager, G.: Real-time endoscopic mosaicking. In: (MIC [symbol] CAI). (LNCS), Copenhagen, Denmark, Springer (2006) 355-363
6. Totz, J., Mòuntney, P., Stoyanov, D., Yang, G. Z.: Dense surface reconstruction for enhanced navigation in MIS. In: (MICCAI). (LNCS), Toronto, Canada, Springer (2011) 89-96
7. Hu, M., Penney, G., Rueckert, D., Edwards, P., Bello, F., Figl, M., Casula, R., Cen, Y., Liu, J., Miao, Z., Hawkes, D.: A robust mosaicing method with super-resolution for optical medical images. In: MIAR. Volume 6326 of LNCS. Springer Berlin (2010) 373-382

### SUMMARY

An augmented field of view imaging system according to an embodiment of the current invention includes a microscope, an image sensor system arranged to receive images of a plurality of fields of view from the microscope as at least one of the microscope and an object is moved relative to each other as the object is being viewed and to provide corresponding image signals, an image processing and data storage system configured to communicate with the image sensor system to receive the image signals and to provide augmented image signals, and at least one of an image injection system or an image display system configured to communicate with the image processing and data storage system to receive the augmented image signals and display an augmented field of view image. The image processing and data storage system is configured to track the plurality of fields of view in real time and register the plurality of fields of view to calculate a mosaic image. The augmented image signals from the image processing and data storage system provide the augmented image such that a live field of view from the microscope is composited with the mosaic image.

### BRIEF DESCRIPTION OF THE DRAWINGS

Further objectives and advantages will become apparent from a consideration of the description, drawings, and examples.

FIGS. 1A and 1B show typical views of the retina through the surgical microscope during vitreo-retinal surgery. FIG. 1A: simulation using retinal phantom; FIG. 1B: in vivo rabbit retina.

FIGS. 2A and 2B show a couple of examples of augmented fields-of-view of retinas using image tracking, image mosaicking and image compositing according to an embodiment of the current invention. The grayscale regions represent the retinal map (mosaic) registered to the color (live) retinal view. FIG. 2A: simulation using retinal phantom; FIG. 2B: in vivo rabbit retina.

FIG. 3A is a schematic illustration of an augmented field of view microscopy system according to an embodiment of the current invention.

FIG. 3B is an image of an augmented field of view microscopy system corresponding to FIG. 3A.

FIG. 4A is a schematic illustration of an augmented field of view microscopy system according to another embodiment of the current invention.

FIG. 4B is an image of an augmented field of view microscopy system corresponding to FIG. 4A.

FIG. 5 helps illustrate some concepts of a hybrid tracking and mosaicking method according to an embodiment of the current invention. A direct visual tracking method (left) is combined with a SURF feature map (right) for coping with full occlusions. The result is the intra-operative retina map shown in the middle. Notice the retina map displayed above is a simple overlay of the templates associated with each map position.

FIG. 6 is a schematic diagram to help explain a tracking system according to an embodiment of the current invention.

FIG. 7 shows examples of intra-operative retina maps obtained using the hybrid tracking and mosaicking method according to an embodiment of the current invention.

FIG. 8 shows an example of a quantitative analysis: the average tracking error of four points arbitrarily chosen on the rabbit retina is manually measured. Slight tracking drifts are highlighted in the plot.

FIG. 9A shows an example in which a considerable smaller retina map is obtained when tracking in gray-scale images. FIG. 9B: Poor tracking quality measurements lead to the incorporation of incorrect templates to the map in areas with little texture.

FIG. 10 shows that annotations created by a mentor on the intra-operative mosaic can be overlaid on the novice surgeon view for assistance and guidance during surgery. The mosaic could also be displayed to the surgeon for facilitating the localization of surgical targets.

FIG. 11A shows an image of ERM peeling; and FIG. 11B shows the corresponding OCT B-Scan of the retina [Ref. 2 of Examples 2].

FIG. 12 shows components of the imaging and visualization system according to an embodiment of the current invention.

FIGS. 13A and 13B show a user interface. A) Creating M-Scan with OCT probe. B) Review mode with forceps as input.

FIG. 14A shows a structured template grid on a retina model according to an embodiment of the current invention. FIG. 14B shows templates matching with candidate image. Colors show level of match confidence: red is low, orange is medium, and green is high. Note: matching confidence is low over the tool and its shadow. FIG. 14C shows back projection of original templates.

FIG. 15 is a schematic of a retina tracker algorithm processing single video frame according to an embodiment of the current invention.

FIGS. 16A and 16B show A) M-Scan in Eye Phantom with tape simulating ERM used for validation of overall tracking. B) M-Scan with silicone layer (invisible ERM) demonstrating more realistic surgical scenario. The surgeon uses the forceps as a pointer to review the M-Scan. The green circle is the projection of the pointer on the M-Scan path and corresponds to the location of the blue line on the OCT image and the zoomed-in high-resolution OCT “slice” image on the left.

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention. All references cited anywhere in this specification, including the Background and Detailed Description sections, are incorporated by reference as if each had been individually incorporated.

The term “real-time” is intended to mean that the images can be provided to the user during use of the system. In other words, any noticeable time delay between detection and image display to a user is sufficiently short for the particular application at hand. In some cases, the time delay can be so short as to be unnoticeable by a user.

During ophthalmic retinal diagnostic and interventional procedures the physician's field of view is severely limited by the physical constraints of the human pupil and the optical properties of the ophthalmic camera or microscope. During the most delicate procedures, only a minute fraction of the whole retinal surface may be visible at a time which makes navigation and localization difficult. An embodiment of the current invention can help physicians navigate on the retina by augmenting the live retinal view by overlaying a wide angle panoramic map of the retina on the live display while maintaining an accurate registration between the retinal features on the live view and the retinal map. The extended view gained by applying this method places the minute fraction of the whole retinal surface visible at a time into the greater context of a larger retinal map that aids physicians to properly identify their current view location.

Ophthalmologists often need to be able to identify specific targets on the retinal surface based on the geometry and the visual features visible on the retina. The position of these targets follow the movement of the retina and occasionally they may move out of sight which makes the recognition of these targets more challenging when they move back to the live view. Another embodiment of the current invention can enable the display of visual annotations that are affixed to the wide-angle retinal map and their locations on the live image are thus registered to the current live view. Using this method when the targets move out of sight on the live view, the registration of the attached visual annotations can be maintained and the annotations may be displayed outside of the current view, on the unused parts of the video display.

Accordingly, some embodiments of the current invention can provide systems and methods to display context-aware annotations and overlays on live ophthalmic video and build wide-angle images from a sequence of narrow angle retinal images by tracking image features. The systems and methods can operate substantially in real-time according to some embodiments of the current invention. Some embodiments of these methods maintain a database of observed retinal features, construct the database dynamically as new observations become available, and provide a common coordinate system to identify the observed image features between the live ophthalmic image and the annotations and overlays.

Some embodiments of the current invention can provide the ability to detect and track and redetect visual features on the retina surface robustly and in real time, the ability to map a large area of the retinal surface from separate observations of small areas of retinal surface in real time, the ability to superimpose large maps of retinal surface onto narrow-field retinal images, and the ability to tie visual annotations to locations on retinal surface maps and display them in real time.

### Image Tracking and Mosaicking

As described in more detail below, methods according to some embodiments of the current invention are able to detect and track visual features on the retina and register them to other image data records in order to localize the live field of view. The methods also keep track of changes in retinal features in order to make registration possible between images taken at different points of time. Challenges in retina imaging during diagnostic and interventional retinal procedures present a series of difficulties for computational analysis of retinal images. The quality of images acquired by the ophthalmic retinal camera is heavily degraded by dynamic image deformations, occlusions, and continuous focal and illumination changes. Also, typically only a small area of the retina is visible at any time during the procedure, an area so small that it may not contain enough visual detail for accurate tracking between video frames. In order to accurately characterize retina motion, some embodiments provide an image processing method that uses application specific pre-processing and robust image-based tracking algorithms. The accuracy of tracking methods in some embodiments of the current invention can enable real-time image mosaicking that is achieved by transforming retinal images taken at different locations and different points in time to the same spatial coordinate system and blending them together using image processing methods.

Two embodiments of ophthalmic image tracking are described in more detail with reference to the examples. One embodiment employs multi-scale template matching using a normalized cross-correlation method to determine position, scale and rotation changes between video frames and to build an image mosaic.

The second embodiment of ophthalmic image tracking employs Sum of Conditional Variances (SCV) metric for evaluating image similarity in an iterative gradient descent framework to perform tracking and further robustifies the method by enabling recovery of lost tracking using feature-based registration.

### Intra-Operative Mosaic Image Compositing In Vitreo-Retinal Surgery

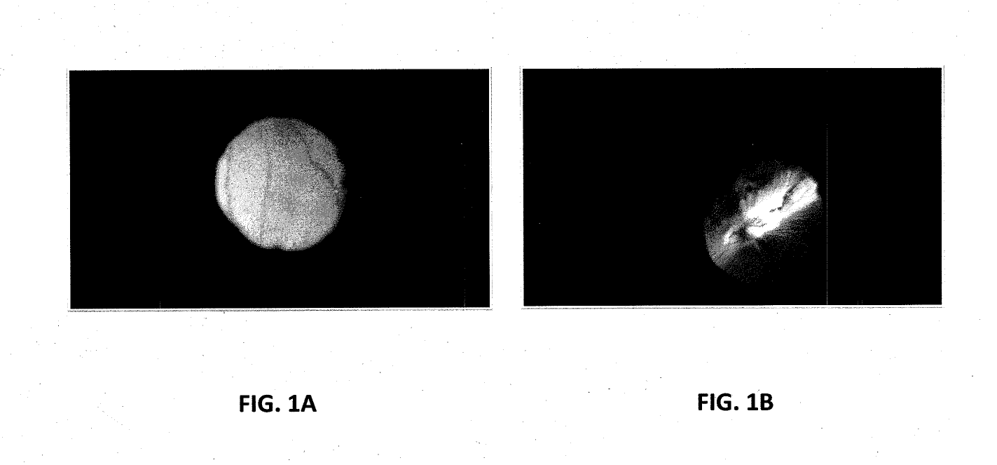

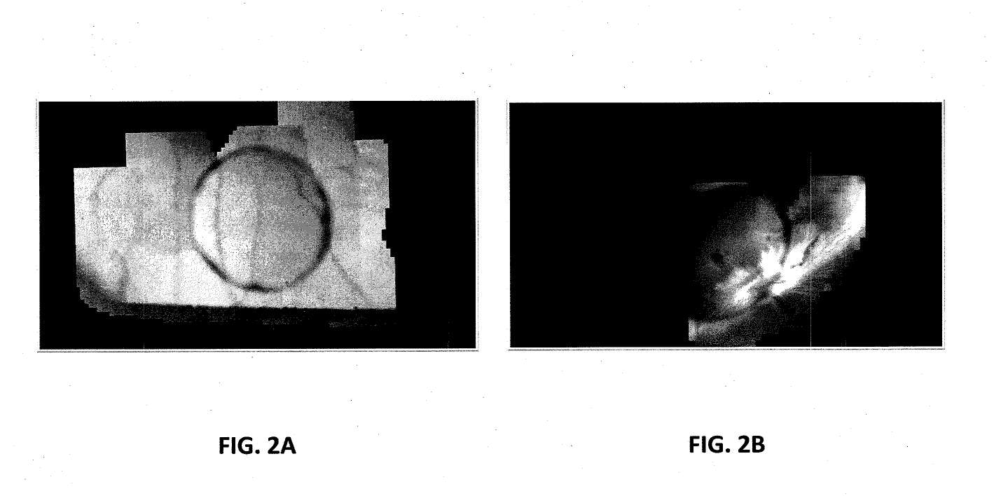

During vitreo-retinal surgery, the field of view of the surgical microscope is often limited to a minute fraction of the whole retina. Typically this minute fraction appears on the live image as a small patch of the retina on a predominantly black background. The shape of the patch is determined by the shape of the pupil, which is usually a circular or elliptical disk (FIG. 1). In order to help surgeons localize their current view with respect to the whole retina, according to an embodiment of the current invention, we superimpose the previously seen areas of the retina on the black area surrounding the pupil region (FIG. 2). Using the unused, dark regions of the image we avoid obstructing the live view of the retina.

There are several challenges to being able to perform this task:
Determining the location, size and shape of the pupil on the microscopic image.
Creating a background mask, that labels each image pixel according to whether they belong to the retinal image as seen through the pupil or the dark background. The mask may also specify a blending coefficient for each pixel in order to smooth the transition between the pupil and background.
Maintaining a database of retinal images seen through the pupil.
Tracking the motion of the retinal surface visible through the pupil.
Building a wide-angle retina map image by registering retinal surface images seen through the pupil to each other and pasting them on the retina map (image mosaicking).
Transforming the retina map image into the coordinate frame of the current view through the pupil.
Superimposing the transformed wide-angle retina map on the microscopic image using the background map.
Displaying the resulting image for the surgeon.
Performing all these operations in real-time.

### Finding the Outlines of the Pupil and Creating Background Mask

Since the shape of the retinal region on the microscopic image is a circular or elliptical, it can be sufficient to calculate the ellipse equation that fits on the disk boundaries in order to model the outlines. The following steps are performed according to an embodiment of the current invention in order to determine the parameters of the ellipse and create the background mask:
Image thresholding
Calculate center of weight
Compute intensity profile along 32 equally distributed radial lines around the center of weight
Determine the location of the bright-to-dark transition that is the farthest from the center of weight along each radial line, resulting in the coordinates of 32 points
Fit an ellipse on the resulting 32 points
Mark all pixels outside of the ellipse as background and all pixels inside the ellipse as pupil on the background mask

The general concepts of the current invention are limited to this example. The examples below describe some embodiments of image tracking and mosaicking in more detail.

Standard per-pixel image blending methods may be used for compositing the retinal map and the live microscopic image. A blending coefficient for each image pixel is obtained from the background map.

Displaying additional information on the microscopic view can be provided by either image injection or video microscopy. In the former case, visual information is injected in the optical pathways of the surgical microscope so that the surgeon can see that information through the microscope's optical eye-piece. In the latter case, an imaging sensor is attached to the surgical microscope such that the view that the surgeon would see through the eye-piece is captured into digital images in a processing device. The processor then superimposes the additional visual information on the digitally stored microscopic images and sends the resulting image to a video display.

The image injection system also needs to be equipped with an image sensor for digitizing the live microscopic image in order to make image tracking of the localization of the pupil area possible.

### Context-Aware Annotations for Mentoring in Ophthalmic Surgery

During surgical training of vitreo-retinal procedures, instructor and trainee surgeons both sit in front of the surgical microscope. The instructor sits at the assistant scope, the trainee sits at the main eyepiece. Communication between instructor and trainee typically is limited to spoken words which presents difficulties when the instructor needs to point out specific locations on the retina for the trainee.

The following describes an application of context-aware annotations in retinal surgery that employs visual markers to aid communication between mentor and trainee according to an embodiment of the current invention.

The instructor is provided with a touch screen display on his side that shows a wide-angle map of the retina (mosaic) that is constructed in real time as the trainee moves the view around and explores the retina region by region. When the instructor at any point needs to point out the location of a point-of-interest (POI) on the retina surface, he looks at the retina map on the touch screen and using his finger he draws a marker on the touch screen at the location of the POI (e.g. circles the area, adds a crosshair, etc.) and tells the trainee to move the view to the location of the marker. At the same time, if the microscope is equipped with an image injection system, the marker gets displayed in the main scope overlaid on the live microscopic image. Or, if there is no image injection system available, a stereoscopic display mounted next to the scope displays the live microscopic image and the superimposed marker position. The marker is a visual annotation that remains registered to the live image at all times and moves with the retina on the location that the instructor pointed out. When the POI moves out of the current retinal view, the registration is still preserved with respect to the current view and displayed on the unused, dark areas of the display surrounding the retinal view.

This embodiment employs an image sensor attached to the surgical microscope, processing hardware, a touch sensitive display device mounted by the side of instructor, and a display device (or image injection system) to visualize a live microscopic image for the trainee surgeon. The image sensor device captures the microscopic view as digital images that are transferred to the processing hardware, then after processing, the retina map is displayed on the touch screen and the live microscopic image featuring visual annotations is displayed on the live image display or image injection system.

The processor performs the following operations:
Determining the location, size and shape of the pupil on the microscopic image.
Maintaining a database of retinal images seen through the pupil.
Tracking the motion of the retinal surface visible through the pupil.
Building a wide-angle retina map image by registering retinal surface images seen through the pupil to each other and pasting them on the retina map.
Displaying retina map on the touch sensitive display device.
Superimposing markers on microscopic image while maintaining registration of markers with respect to current retinal view using information provided by the image tracker.
Displaying the resulting image for the trainee surgeon on the live image display or image injection system.
Performing all these operations in real-time.

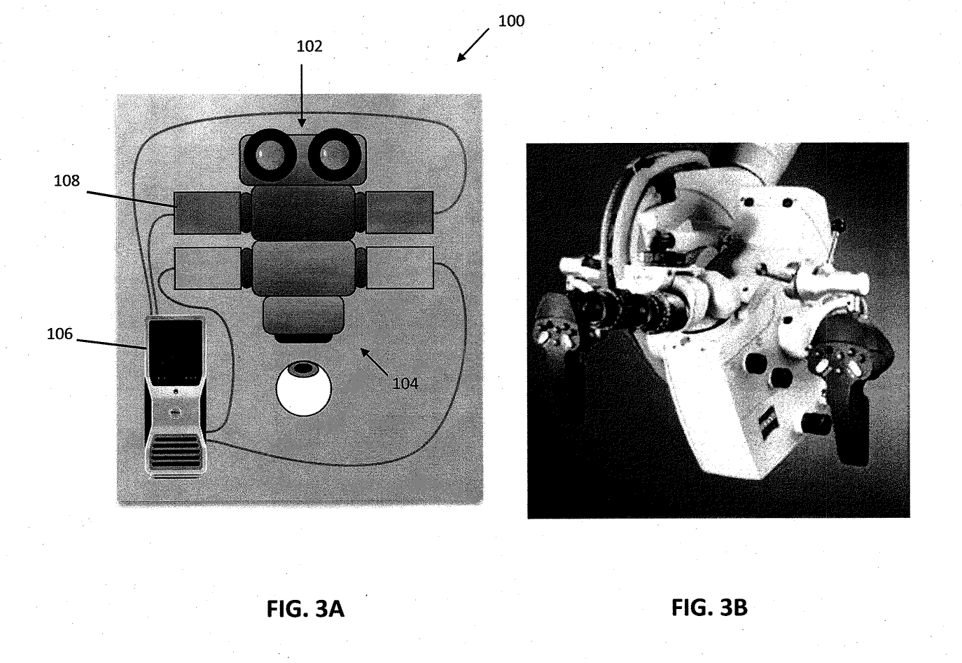

FIG. 3A provides a schematic illustration of an augmented field of view imaging system 100 according to an embodiment of the current invention. The augmented field of view imaging system 100 includes a microscope 102, an image sensor system 104 arranged to receive images of a plurality of fields of view from the microscope 102 as the microscope 102 is moved relative to an object being viewed and to provide corresponding image signals, and an image processing and data storage system 106 configured to communicate with the image sensor system 104 to receive the image signals and to provide augmented image signals. The augmented field of view imaging system 100 includes at least one of an image injection system 108 or an image display system configured to communicate with the image processing and data storage system 106 to receive the augmented image signals and display an augmented field of view image. In the embodiment of FIG. 3A, the augmented field of view imaging system 100 includes the image injection system 108.

The image processing and data storage system 106 is configured to track the plurality of fields of view in real time and register the plurality of fields of view to provide a mosaic image. The augmented image signals from said image processing and data storage system 106 provide the augmented image such that a live field of view from the optical microscope is composited with the mosaic image.

The microscope 102 can be a stereo microscope in some embodiments. The term microscope is intended to have a broad meaning to include devices which can be used to obtain a magnified view of an object. It can also be incorporated into or used with other devices and components. The augmented field of view imaging system 100 can be a surgical system or a diagnostic system in some embodiments. The image sensor system 104 is incorporated into the structure of the microscope 102 in the embodiment of FIG. 3A. The image processing and data storage system 106 can be a work station or any other suitable localized and/or networked computer system. The image processing can be implemented through software to program a computer, for example, and/or specialized circuitry to perform the functions.

FIG. 3B shows an image of an example of augmented field of view imaging system 100.

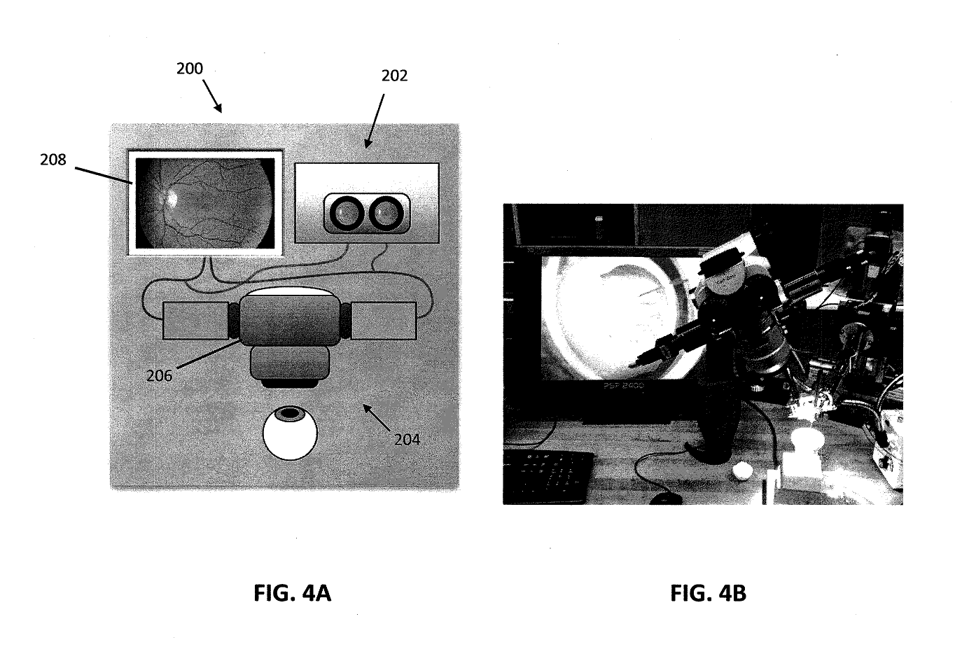

FIG. 4A provides a schematic illustration of an augmented field of view imaging system 200 according to an embodiment of the current invention. The augmented field of view imaging system 200 includes a microscope 202, an image sensor system 204 arranged to receive images of a plurality of fields of view from the microscope 202 as the microscope 202 is moved relative to an object being viewed and to provide corresponding image signals, and an image processing and data storage system 206 configured to communicate with the image sensor system 204 to receive the image signals and to provide augmented image signals. The augmented field of view imaging system 200 includes at least one of an image injection system or an image display system 208 configured to communicate with the image processing and data storage system 206 to receive the augmented image signals and display an augmented field of view image. In the embodiment of FIG. 4A, the augmented field of view imaging system 200 includes an image display system 208.

The image processing and data storage system 206 is configured to track the plurality of fields of view in real time and register the plurality of fields of view to provide a mosaic image. The augmented image signals from said image processing and data storage system 206 provide the augmented image such that a live field of view from the microscope is composited with the mosaic image.

The microscope 202 can be a stereo microscope in some embodiments. The augmented field of view imaging system 200 can be a surgical system or a diagnostic system in some embodiments. The image sensor system 204 is incorporated into the structure of the microscope 202 in the embodiment of FIG. 4A. The image processing and data storage system 206 can be a work station or any other suitable localized and/or networked computer system. The image processing can be implemented through software to program a computer, for example, and/or specialized circuitry to perform the functions.

FIG. 4B shows an image of an example of augmented field of view imaging system 200.

Augmented field of view imaging system 100 and/or 200 can also include a touchscreen display configured to communicate with the image processing and data storage system (106 or 206) to receive the augmented image signals. The image processing and data storage system (106 or 206) can be further configured to receive input from the touchscreen display and to display information as part of the augmented image based on the input from the touchscreen display. Other types of input and/or output devices can also be used to annotate fields of view of the augmented field of view imaging system 100 and/or 200. These can provide, but are not limited to, training systems.

Augmented field of view imaging system 100 and/or 200 can also include one or more light sources. In an embodiment, augmented field of view imaging system 100 and/or 200 further includes a light source configured to illuminate an eye of a subject under observation such that said augmented field of view imaging system is an augmented field of view slit lamp system. A conventional slit lamp is an instrument that has a high-intensity light source that can be focused to shine a thin sheet of light into the eye. It is used in conjunction with a biomicroscope.

Further additional concepts and embodiments of the current invention will be described by way of the following examples. However, the broad concepts of the current invention are not limited to these particular examples.

### Example 1

The following is an example of a hybrid Simultaneous Localization and Mapping (SLAM) method designed for the challenging conditions in retinal surgery according to an embodiment of the current invention. This method is a combination of both direct and feature-based tracking methods. Similar to [5] and [8], a two dimensional map of the retina is built on-the-fly using a direct tracking method based on a robust similarity measure called Sum of Conditional Variance (SCV) [9] with a novel extension for tracking in color images. In parallel, a map of SURF features [10] is built and updated as the map expands, enabling tracking to be reinitialized in case of full occlusions. The method has been tested on a database of phantom, rabbit and human surgeries, with successful results. In addition, we demonstrate applications of the system for intra-operative navigation and tele-mentoring systems.

### Methods

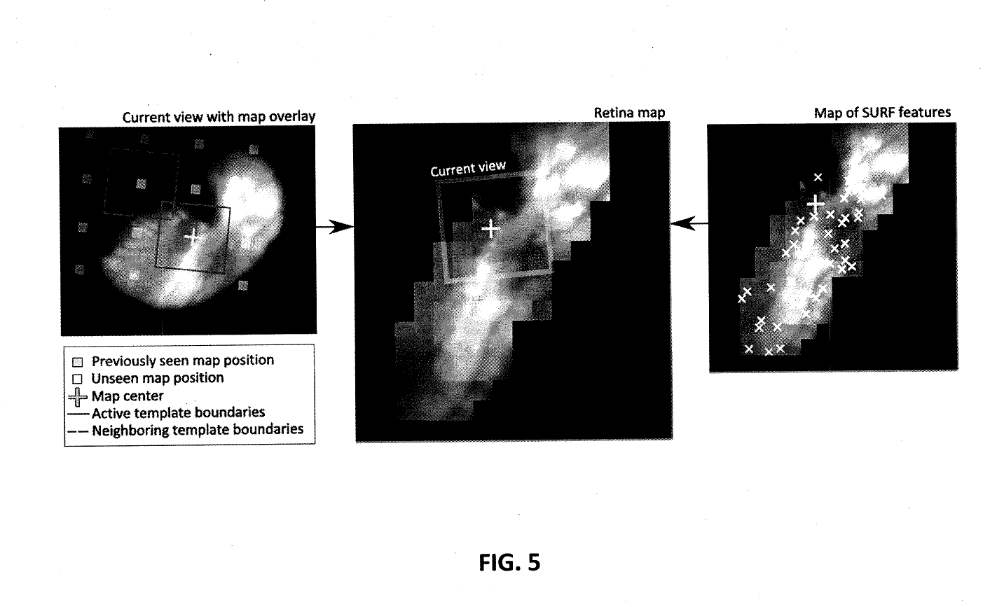

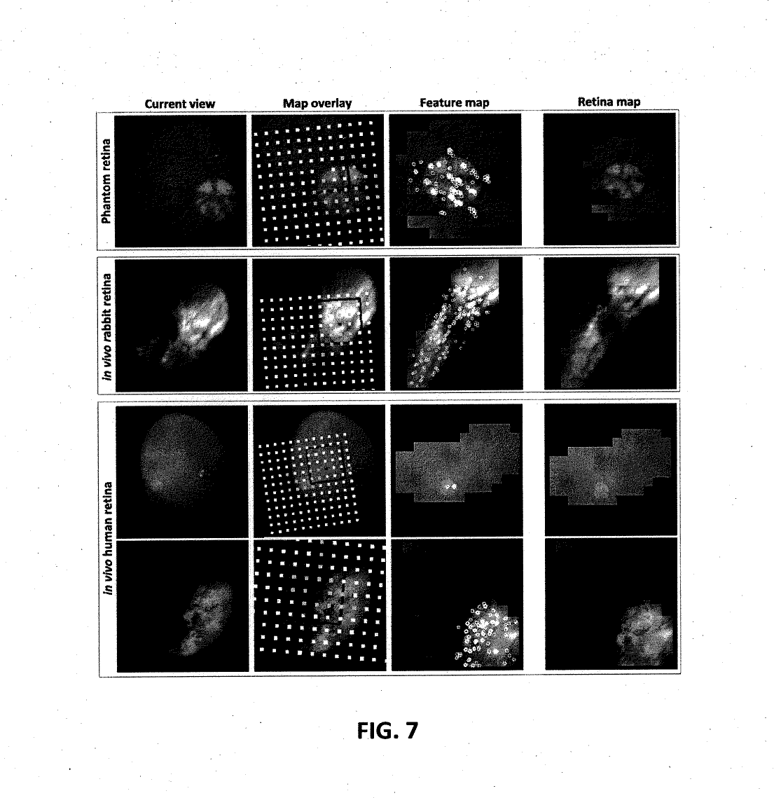

The major components of the exemplar hybrid SLAM method are illustrated in FIG. 5. A combination of feature-based and direct methods was chosen over a purely feature-based SLAM method due to the specific nature of the retina images, where low frequency texture information is predominant. As explained in detail below, a purely feature-based SLAM method could not produce the same results as the exemplar method in the in vivo human datasets shown in FIG. 7 due to the lack of salient features in certain areas of the retina.

During surgery, only a small portion of the retina is visible. For initializing the SLAM method, an initial reference image of the retina is selected. The center of the initial reference image represents the origin of a retina map. As the surgeon explores the retina, additional templates are incorporated into the map, as the distance to the map origin increases. New templates are recorded at even spaces, as illustrated in FIG. 5(left) (notice that regions of adjacent templates overlap). At a given moment, the template closest to the current view of the retina is tracked using the direct tracking method detailed next.

### Direct Visual Tracking Using Robust Similarity Measures

Tracking must cope with disturbances such as illumination variations, partial occlusions (e.g. due to particles floating in the vitreous), distortions, etc. To this end, we tested several robust image similarity measures from the medical image registration domain such as Mutual Information (MI), Cross Cumulative Residual Entropy (CCRE), Normalized Cross Correlation (NCC) and the Sum of Conditional Variance (SCV) (see [9]). Among these measures, the SCV has shown the best trade-off between robustness and convergence radius. In addition, efficient optimizations can be derived for the SCV, which is not the case for NCC, MI or CCRE.

The tracking problem can be formulated as an optimization problem, where we seek to find at every image the parameters p of the transformation function w(x, p) that minimize the SCV between the template and current images T and I(w(x, p)):

$$𝒮𝒞𝒱 ( p ) = {\sum }_{x} {( I ( w ( x , p ) ) - {\hat{T}}_{( i , j )} ( x ) )}^{2} , with \hat{T} ( x ) = ℰ ( I ( w ( x , p ) ) \vert {T}_{( i , j )} ( x ) ) \qquad ( 1 )$$

where ε(.) is the expectation operator. The indexes (i, j) represent the row and column of the template position in the retinal map shown in FIG. 5. The transformation function w(.) is chosen to be a similarity transformation (4 DOFs, accounting for scaling, rotation and translation). Notice that more complex models such as the quadratic model [11] can be employed for mapping with higher accuracy.

In the medical imaging domain, images T and I are usually intensity images. Initial tests of retina tracking in gray-scale images yielded poor tracking performance due to the lack of image texture in certain parts of the retina. This motivated the extension of the original formulation in equation (1) to tracking in color images for increased robustness:

$${𝒮𝒞𝒱}^{*} ( p ) = {\sum }_{c} {\sum }_{x} {( {}^{c} I ( w ( x , p ) ) - {}_{}^{c}{\hat{T}}{}_{( i , j )}^{} ( x ) )}^{2} \qquad ( 2 )$$

In the specific context of retinal images, the blue channel could be ignored as it is not a strong color component. Hence, tracking is performed using red and green channels. For finding the transformation parameters p that minimize equation (2), the Efficient Second-Order Minimization (ESM) strategy is adopted [8]. Finally, it is important to highlight the fact that new templates are only incorporated to the retina map when tracking confidence is high (i.e. over an empirically defined threshold ε). Once a given template is incorporated to the map, it is no longer updated. Tracking confidence is measured as the average NCC between ^{c}T and ^{c}I(w(x, p)) over all color channels c.

### Creating a Feature Map

For recovering tracking in case of full occlusions, a map of SURF features on the retina is also created. For every new template incorporated in the map, the set of SURF features within the new template is also included. Due to the overlap between templates, the distance (in pixels) between old and new features on the map is measured, and if it falls below a certain threshold λ, the two features are merged by taking the average of their positions and descriptor vectors.

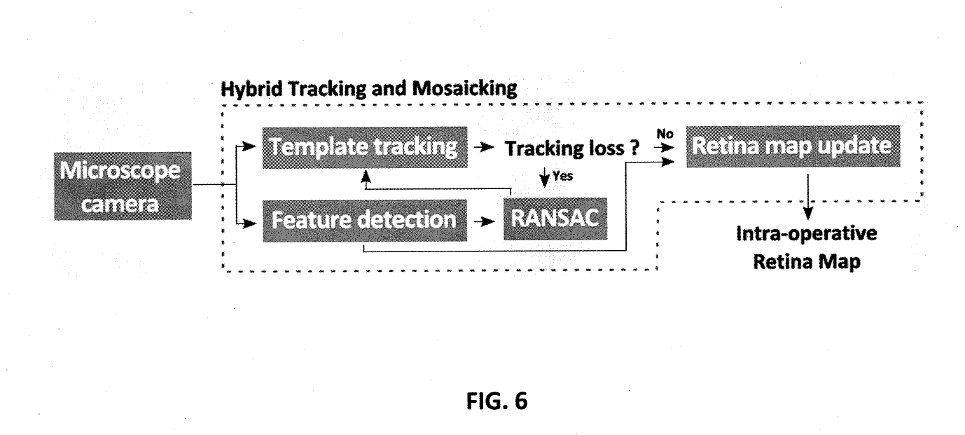

Parallel to template tracking, SURF features are detected in every new image of the retina. If tracking confidence drops below a pre-defined threshold ε, tracking is suspended. For re-establishing tracking, RANSAC is employed. In practice, due to the poor visualization conditions in retinal surgery, the SURF Hessian thresholds are set very low. This implies in a high number of false matches and consequently a high number of RANSAC iterations. A schematic diagram of the hybrid SLAM method is shown in FIG. 6.

### Experiments

For acquiring phantom and in vivo rabbit images, we use a FireWire Point Grey camera acquiring 800×600 pixel color images at 25 fps. For the in vivo human sequences, a standard NTSC camera acquiring 640×480 color images was used. The method was implemented using OpenCV on a Xeon 2.10 GHz machine. The direct tracking branch (see FIG. 6) runs at frame-rate while the feature detection and RANSAC branch runs at ≈6 fps (depending on the number of detected features). Although the two branches already run in parallel, considerable speed gains can be achieved with further code optimization.

### Reconstructed Retina Maps

FIG. 7 shows examples of retina maps obtained according to the current example. For all sequences, we set the template size for each map position to 90×90 pixels. Map positions are evenly spaced by 30 pixels. Due to differences in the acquisition setup (zoom level, pupil dilation, etc.), the field of view may vary between sequences. The rabbit image dataset consists of two sequences of 15s and 20s and the human image datasets consist of two sequences of 46s and 39s (lines 3 and 4 in FIG. 3, respectively). The tracking confidence threshold ε for incorporating new templates and the threshold λ for detecting tracking failure were empirically set to 0.95 and 0.6, respectively, for all experiments. In addition, the number of RANSAC iterations was set to 1000.

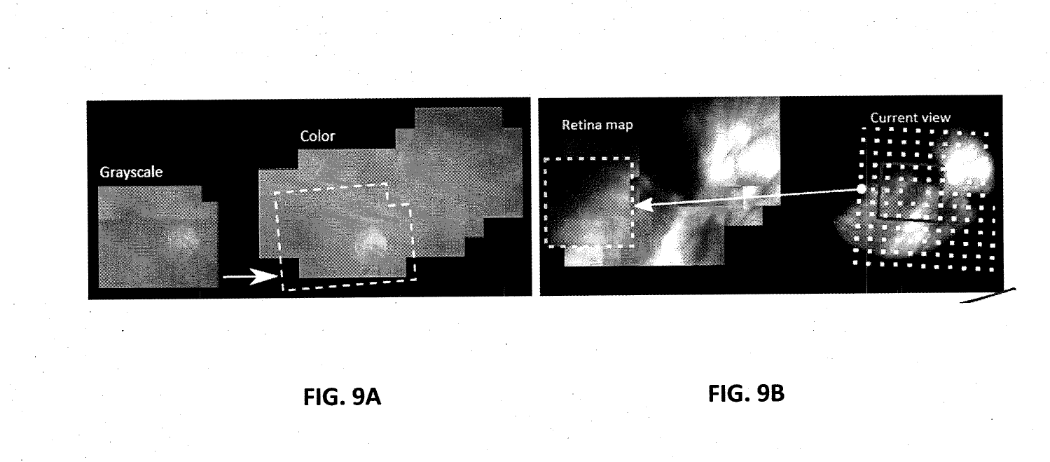

The advantages of this approach to tracking in color are clearly shown in the experiments with human in vivo images. In these specific images, much information is lost in the conversion to gray-scale, reducing the tracking convergence radius and increasing chances of tracking failure. As a consequence, the estimated retina map is considerably smaller than when tracking in color images (see example in FIG. 9A).

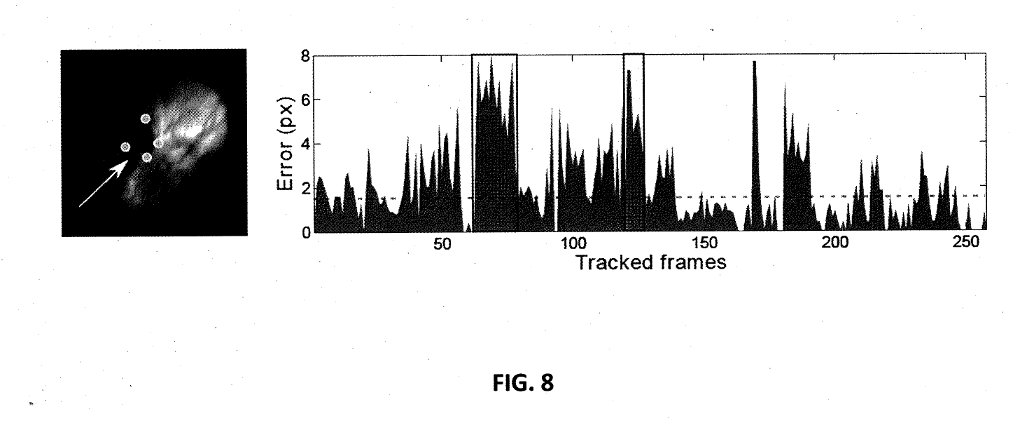

For a quantitative analysis of the proposed method, we manually measured the tracking error (in pixels) of four points arbitrarily chosen on 500 images of the rabbit retina shown in FIG. 8. The error is only measured when tracking is active (i.e. tracking confidence above c). In average, tracking error is below 1.60±3.1 pixels, which is close the manual labeling accuracy (estimated to be ≈1 pixel). Using the surgical tool shaft as reference in this specific image sequence, the ratio between pixels and millimeters is approximately 20 px/mm. From the plot, slight tracking drifts can be detected (from frame intervals [60,74] and [119,129] highlighted in the plot), as well as error spikes caused by image distortions. Overall, even though tracking accuracy is too large for applications such as robotic assisted vein cannulation, it is sufficient for consistent video overlay.

### Applications

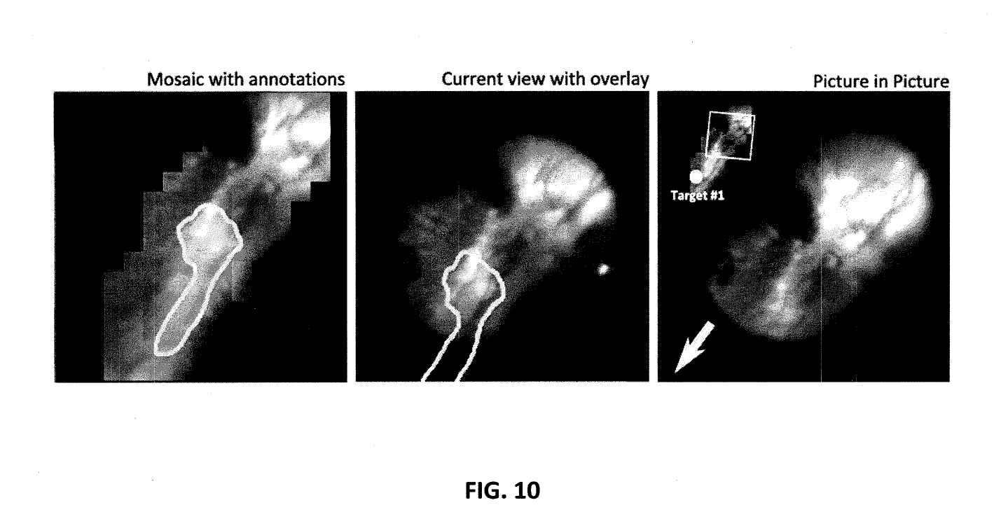

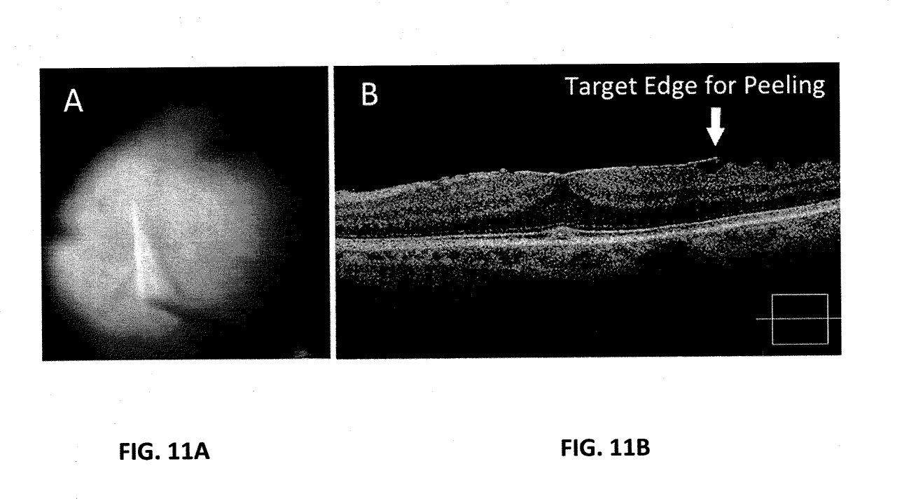

The hybrid SLAM method according to an embodiment of the current invention can be applied in a variety of scenarios. The most natural extension would be the creation of a photo realistic retina mosaic based on the SLAM map, taking advantage of the overlap between stored templates. The exemplar system could also be used in an augmented reality scenario for tele-mentoring. Through intra-operative video overlay, a mentor could guide a novice surgeon by indicating points of interest on the retina, demonstrate surgical gestures or even create virtual fixtures in a robotic assisted scenario (see FIG. 10(left-middle)). Similar to [4], the proposed SLAM method can also be used for intra-operative guidance, facilitating the localization and identification of surgical targets as illustrated in FIG. 10 (right).

### Conclusion

In this example we describe a hybrid SLAM method for view expansion and surgical guidance during retinal surgery. The system is a combination of direct and feature-based tracking methods. A novel extension for direct visual tracking using a robust similarity measure named SCV in color images is provided. Several experiments conducted on phantom, in vivo rabbit and human images illustrate the ability of the method to cope with the challenging retinal surgery scenario. Furthermore, applications of the method for tele-mentoring and intra-operative guidance are demonstrated. We focused on the study of methods for detecting distinguishable visual features on the retina for improving robustness to occlusions. We also studied methods for registering pre-operative Fundus images with the intra-operative retina map for improving the map accuracy and extend the system capabilities.

### REFERENCES FOR EXAMPLE 1

1. Mitchell, B., Koo, J., Iordachita, I., Kazanzides, P., Kapoor, A., Handa, J., Taylor, R., Hager, G.: Development and application of a new steady-hand manipulator for retinal surgery. In: ICRA, Rome, Italy (2007) 623-629
2. Bergeles, C., Kummer, M. P., Kratochvil, B. E., Framme, C., Nelson, B. J.: Steerable intravitreal inserts for drug delivery: in vitro and ex vivo mobility experiments. In: MICCAI. (LNCS), Toronto, Canada, Springer (2011) 33-40
3. Balicki, M., Han, J., Iordachita, I., Gehlbach, P., Handa, J., Taylor, R., Kang, J.: Single fiber optical coherence tomography microsurgical instruments for computer and robot-assisted retinal surgery. In: MICCAI. Volume 5761 of (LNCS)., London, UK, Springer (2009) 108-115
4. Fleming, I., Voros, S., Vagvolgyi, B., Pezzementi, Z., Handa, J., Taylor, R., Hager, G.: Intraoperative visualization of anatomical targets in retinal surgery. In: IEEE Workshop on Applications of Computer Vision (WACV'08). (2008) 1-6
5. Seshamani, S., Lau, W., Hager, G.: Real-time endoscopic mosaicking. In: (MICCAI). (LNCS), Copenhagen, Denmark, Springer (2006) 355-363
6. Totz, J., Mountney, P., Stoyanov, D., Yang, G. Z.: Dense surface reconstruction for enhanced navigation in MIS. In: (MICCAI). (LNCS), Toronto, Canada, Springer (2011) 89-96
7. Hu, M., Penney, G., Rueckert, D., Edwards, P., Bello, F., Figl, M., Casula, R., Cen, Y., Liu, J., Miao, Z., Hawkes, D.: A robust mosaicing method with super-resolution for optical medical images. In: MIAR. Volume 6326 of LNCS. Springer Berlin (2010) 373-382
8. Silveira, G., Malis, E., Rives, P.: An efficient direct approach to visual SLAM. IEEE Transactions on Robotics 24(5) (2008) 969-979
9. Pickering, M., Muhit, A. A., Scarvell, J. M., Smith, P. N.: A new multi-modal similarity measure for fast gradient-based 2d-3d image registration. In: EMBC, Min-neapolis, USA (2009) 5821-5824
10. Bay, H., Ess, A., Tuytelaars, T., Gool, L. V.: Speeded-up robust features (SURF). Computer Vision and Image Understanding 110 (June 2008) 346-359
11. Stewart, C., Tsai, L., Roysam, B.: The dual-bootstrap iterative closest point algorithm with application to retinal image registration. IEEE Transactions on Pattern Analysis and Machine Intelligence (PAMI) 22(1) (2003) 1379-1394

### Example 2

Vitreoretinal surgery treats many sight-threatening conditions, the incidences of which are increasing due to the diabetes epidemic and an aging population. It is one of the most challenging surgical disciplines due to its inherent micro-scale, and to many technical and human physiological limitations such as intraocular constraints, poor visualization, hand tremor, lack of force sensing, and surgeon fatigue. Epiretinal Membrane (ERM) is a common condition where 10-80 μm thick scar tissue grows over the retina and causes blurred or distorted vision [1]. Surgical removal of an ERM involves identifying or creating an “edge” that is then grasped and peeled. In a typical procedure, the surgeon completely removes the vitreous from the eye to access to the retina. The procedure involves a stereo-microscope, a vitrectomy system and an intraocular light guide. Then, to locate the transparent ERM and identify a potential target edge, the surgeon relies on a combination of pre-operative fundus and Optical Coherence Tomography (OCT) images, direct visualization often enhanced by coloring dyes, as well as mechanical perturbation in a trial-and-error technique [2]. Once an edge is located, various tools can be employed, such as forceps or a pick, to engage and delaminate the membrane from the retina while avoiding damage to the retina itself. It is imperative that all of the ERM is removed, which can be millimeters in diameter, often requiring a number of peels in a single procedure.

The localization of the candidate peeling edges is difficult. Surgeons rely on inconsistent and inadequate preoperative imaging due to developing pathology, visual occlusion, and tissue swelling and other direct effects of the surgical intervention. Furthermore, precision membrane peeling is performed under very high magnification, visualizing only a small area of the retina (˜5-15%) at any one time. This requires the surgeon to mentally register sparse visual anatomical landmarks with information from pre-operative images, and also consider any changes in retinal architecture due to the operation itself.

To address this problem we developed a system for intraoperative imaging of retinal anatomy according to an embodiment of the current invention. It combines intraocular OCT with video microscopy and an intuitive visualization interface to allow a vitreoretinal surgeon to directly image sections of the retina intraoperatively using a single-fiber OCT probe and then to inspect these tomographic scans interactively, at any time, using a surgical tool as a pointer. The location of these “M-Scans” is registered and superimposed on a 3D view of the retina. We demonstrate how this system is used in a simulated ERM imaging and navigation task.

An alternative approach involves the use of a surgical microscope with integrated volumetric OCT imaging capability such as the one built by Ehlers et al [3]. Their system is prohibitively slow; requires ideal optical quality of the cornea and lens; and lacks a unified display, requiring the surgeon to look away from the surgical field to examine the OCT image increasing the risk of inadvertent collision between tools and delicate inner eye structures. Fleming et al. proposed registering preoperative OCT annotated fundus images with intraoperative microscope images to aid in identifying ERM edges [4], however, they did not present a method to easily inspect the OCT information during a surgical task. It is also unclear whether preoperative images would prove useful if the interval between the preoperative image acquisition and surgery permits advancement of the ERM. Other relevant work uses OCT scanning probes capable of real-time volumetric images [5], but these are still too large and impractical for clinical applications. A single fiber OCT probe presented in [6] has a practical profile but their system does not provide any visual navigation capability. Studies in other medical domains [7-9] have not been applied to retinal surgery, and all, except for [9], rely on computational stereo that is very difficult to achieve in vitreoretinal surgery due to the complicated optical path, narrow depth of field, extreme image distortions, and complex illumination conditions.

### System Overview

At the center of the current example system is a visualization system that captures stereo video from the microscope, performs image enhancement, retina and tool tracking, manages annotations, and displays the results on a 3D display. The surgeon uses the video display along with standard surgical tools, such as forceps and a light pipe, to maneuver inside the eye. The OCT image data is acquired with a handheld probe and sent to the visualization workstation via an Ethernet. Both applications are developed using cisst-saw open-source C++ framework [11] for its stereo-vision processing, multithreading, and inter-process communication. Data synchronization between machines relies on Network Time Protocol.

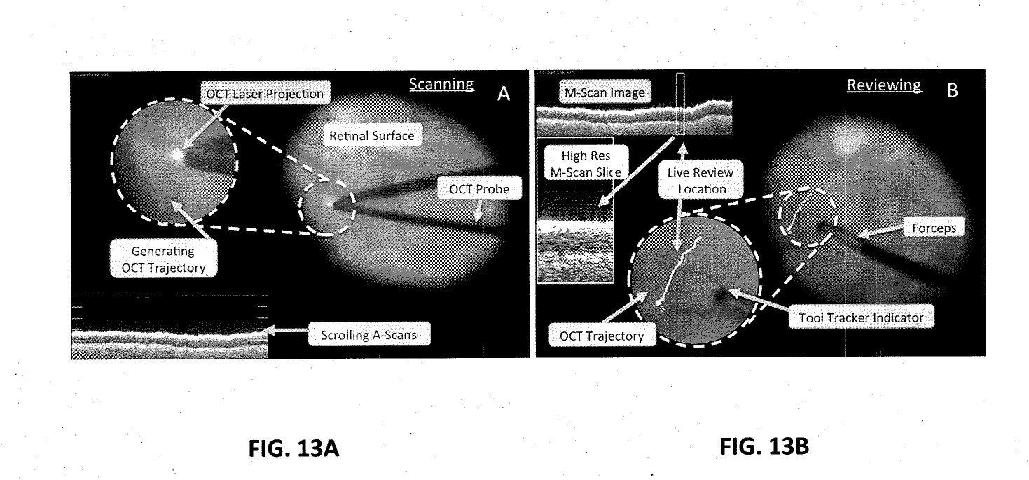

With the above components, we have developed an imaging and annotation functionality called an M-Scan that allows a surgeon to create a cross-sectional OCT image of the anatomy and review it using a single visualization system. For example, the surgeon inserts the OCT probe into the eye, through a trocar, so that the tip of the instrument is positioned close to the retina and provides sufficient tissue imaging depth. The surgeon presses a foot pedal while translating the probe across a region of interest. Concurrently, the system is tracking the trajectory of the OCT relative to the retina in the video and recording the OCT data, as illustrated in FIG. 13A. The surgeon can add additional M-Scans by repeating the same maneuver. The location of these M-Scans is internally annotated on a global retina map and then projected on the current view of the retina. The surgeon reviews the scan by pointing a tool at a spot on the M-Scan trajectory while the corresponding high-resolution section of the OCT image is displayed, see FIG. 13B.

### Optical Coherence Tomography

OCT is a popular, micron-resolution imaging modality that can be used to image the cross-section of the retina to visualize ERMs, which appear as thin, highly reflective bands anterior to the retina. We developed a common path Fourier domain OCT subsystem described fully in [11]. It includes an 840 nm laser source (SLED) with a spectral width of 50 nm. A custom built spectrometer is tuned to provide a theoretical axial resolution of 6.2 μm and a practical imaging range of ˜2 mm in water when used with single fiber probes. The OCT probes are made using standard single mode fiber, with 9 μm core, 125 μm cladding, and 245 μm dia. outer coating, bonded inside a 25 Ga. hypodermic needle. Although, OCT imaging can be incorporated into other surgical instruments such as hooks [6] and forceps, we chose a basic OCT probe because this additional functionality is not required for the experiments where peeling is not performed. The system generates continuous axial scan images (A-Scan is 1×1024 pixels) at ˜4.5 kHz with latency less than 1 ms. The imaging width of each A-Scan is approximately 20-30 μm at 0.5-1.5 mm imaging depth [12]. The scan integration time is set to 50 μs to minimize motion artifacts but is high enough to produce highly contrasting OCT images. By moving a tracked probe laterally, a sample 2D cross-sectional image can be generated. The OCT images are built and processed locally and sent along with A-Scan acquisition timestamps to the visualization station.

### Visualization System

The visualization system uses an OPMI Lumera 700 (Carl Zeiss Meditec) operating stereo-microscope with two custom built-in, full-HD, progressive cameras (60 hz at 1920×1080 px resolution). The cameras are aligned mechanically to have zero vertical disparity. The 3D progressive LCD display is 27″ with 1920×1080 px resolution (Asus VG278) and is used with active 3D shutter glasses worn by the viewer. The visualization application has a branched video pipeline architecture [11] and runs at 20-30 fps on a multithreaded PC. It is responsible for stereo video display and archiving, annotation logic, and the retina and tool tracking described below. The following algorithms operate on an automatically segmented square region of interest (ROI) centered on the visible section of the retina. For the purpose of prototyping the M-Scan concept, this small section of the retina is considered planar for high magnifications. The tracking results are stored in a central transformation manager used by the annotation logic to display the M-Scan and tool locations.

The Retina Tracker continuously estimates a 4DOF transformation (rotation, scaling and translation) between current ROI and an internal planar map of the retina, the content of which is updated after each processed video image. The motion of the retina in the images is computed by tracking a structured rectangular grid of 30×30 px templates equally spaced by 10 px (see FIG. 4). Assuming that rotations and scale are small between image frames, the translation of individual templates visible (g) within the ROI is tracked by a local exhaustive search using Normalized Cross Correlation as the illumination invariant similarity metric (C_{gj}) In the following equations I is the input test image and T is the reference template image, both of the same size, while C_{gj} refers to the jth match in the local neighborhood of a visible template g. The metric operates on the three color channels (RGB) and is calculated as shown below:

$$\begin{matrix}{C}_{gi} = {NCC}_{R} + {NCC}_{G} + {NCC}_{B} where {NCC}_{v} is \text{:} & ( 1 ) \\ {NCC}_{v} = \frac{{\sum }_{x} ( {I}_{x , v} - \overline{{I}_{v}} ) \cdot ( {T}_{x , v} - \overline{{T}_{v}} )}{\sqrt{{\sum }_{x} {( {I}_{x , v} - \overline{{I}_{v}} )}^{2} \cdot \sqrt{{\sum }_{x} {( {T}_{x , v} - \overline{{T}_{v}} )}^{2}}}} , where x are pixels & ( 2 )\end{matrix}$$

To improve robustness when matching in areas of minimal texture variation, the confidence for each template (C_{g}) is calculated by

$${C}_{g} = \frac{max ( {C}_{gi} )}{\overline{{C}_{gi}}} \qquad ( 3 )$$

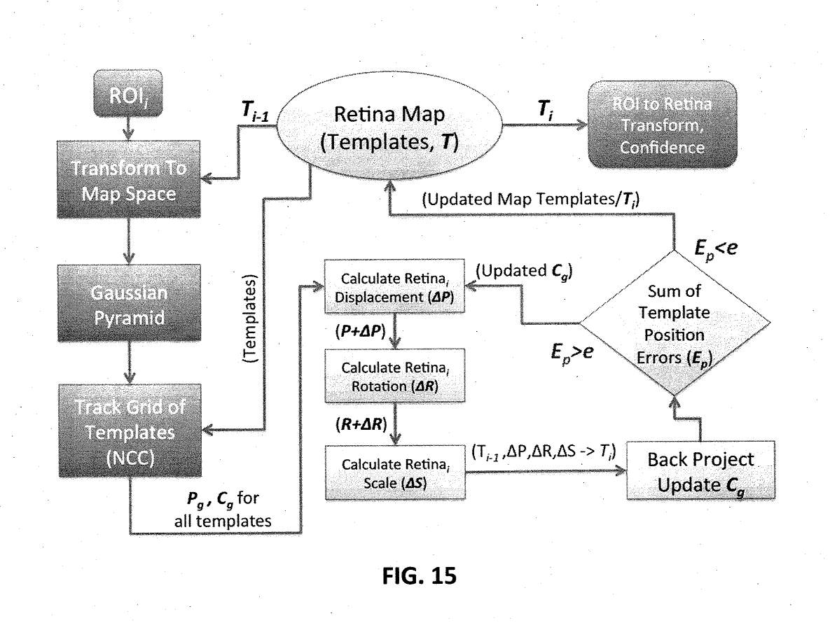

For each template, we store its translation (P_{g}) and corresponding matching confidence. These are then used as inputs for the iterative computation of the 2D rigid transformation from the image to the retinal map. In order to achieve real-time performance considering scaling, a Gaussian pyramid is implemented. The algorithm starts processing in the coarsest scale and propagates the results toward finer resolutions. At each iteration the following steps are executed (see FIG. 15):
A. first, the average of motion (ΔPᵢ) of all visible templates g, weighted by their respective matching confidence (C_{g}), is used to determine the gross translation relative to the reference templates' positions P_{g}°.

$${{Δ P}^{->}}_{i} = \frac{{\sum }_{g} {C}_{g} ( {{P}_{g}}^{} - {{P}_{g}}^{} )}{{\sum }_{g} {C}_{g}} \qquad ( 4 )$$

B. next, the gross rotation is computed by averaging the rotation (ΔRᵢ) of each new template location about the new origin of the visible templates (Pᵢ), again weighted by the confidence:

$$Δ {R}_{i} = a tan 2 ( {\sum }_{g} {C}_{g} \cdot sin α , {\sum }_{g} {C}_{g} \cdot cos α ) , where \text{:} \\ α = a tan 2 ( {{P}_{g , y}}^{} - {{P}_{g , y}}^{} , {{P}_{g , x}}^{} - {{P}_{g , x}}^{} ) - a tan 2 ( {{P}_{g , y}}^{} - {{P}_{g , y}}^{} , {{P}_{g , x}}^{} - {{P}_{g , x}}^{} ) \qquad ( 5 )$$

C. Finally, the scale change (magnification) ΔSᵢ is computed by comparing the average distance of template locations from the origin of the visible subset of the templates on the retina map and the current image:

$$Δ {S}_{i} = \frac{{\sum }_{g} {C}_{g} ‖ {{P}_{g}}^{} - {{P}_{g}}^{} ‖}{{\sum }_{g} {C}_{g} ‖ {{P}_{g}}^{} - {{P}_{g}}^{} ‖} \qquad ( 6 )$$

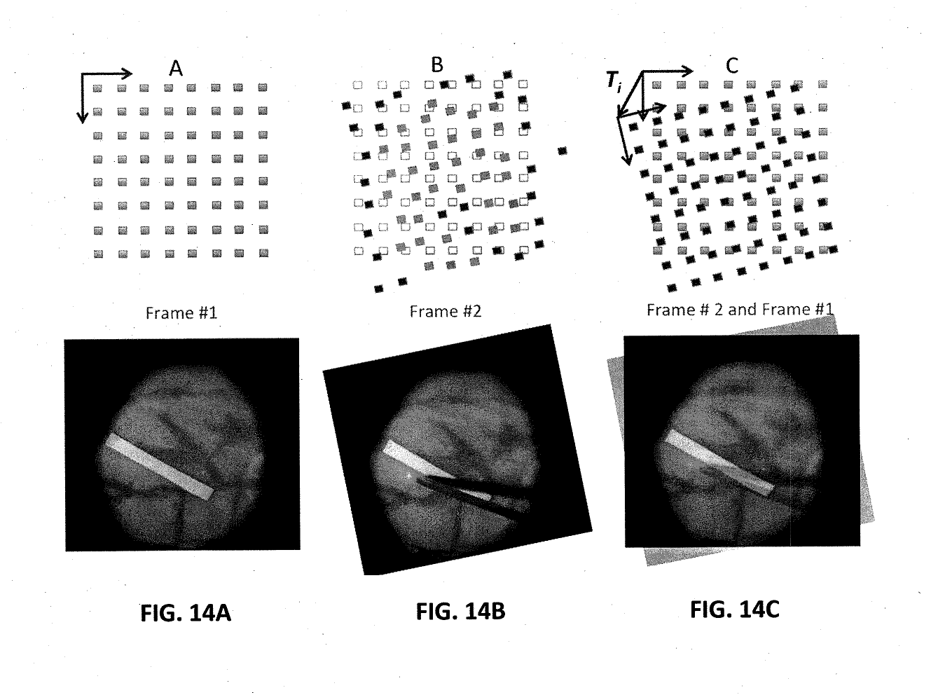

At the end of each iteration, the original template positions are back-projected on the grid and the confidence (C_{g}) of those with high alignment errors (outliers) is reduced. The loop terminates when the sum of template position errors (Eₚ) is below a predefined threshold e, which was chosen empirically to account for environmental conditions and retinal texture. We found this decoupled iterative method to be more reliable in practice than standard weighted least-squares. Outliers usually occur in areas where accurate image displacement cannot be easily established due to specularities, lack of texture, repetitive texture, slow color or shade gradients, occlusion caused by foreground objects, multiple translucent layers, etc. This also implies that any surgical instruments in the foreground are not considered in the frame-to-frame background motion estimation, making the proposed tracker compatible with intraocular interventions (see FIG. 14B). In the case of stereo images, rotation and scale of the left and right retina tracker as well as their vertical disparity are constrained to be the same (averaged) at each iteration of the algorithm.

The OCT Tracker provides the precise localization of the OCT beam projection on the retina which is essential for correlating OCT data with the anatomy. To facilitate segmentation, we chose a camera sensor that captures OCT's near IR light predominantly on its blue RGB channel, as blue hues are uncommon in the retina. The image is first thresholded in YUV color space to detect the blue patch; the area around this patch is then further segmented using adaptive histogram thresholding (AHT) on the blue RGB channel. Morphological operations are used to remove noise from the binary image. This two-step process eliminates false detection of the bright light pipe and also accounts for common illumination variability. The location of the A-Scan is assumed to be at the centroid of this segmented blob. Initial detection is executed on the whole ROI while subsequent inter-frame tracking is performed within a small search window centered on the previous result. Left and right image tracker results are constrained to lie on the same image scan line.

The Tool Tracker: In order to review past M-Scans with a standard surgical instrument, an existing visual tool tracking method for retinal surgery was implemented based on the work by Richa et al [13]. Like the OCT tracker, it operates on the ROI images and generates the tool pose with respect to the ROI of the retina. The algorithm is a direct visual tracking method based on a predefined appearance model of the tool and uses the sum of conditional variance as a robust similarity measure for coping with illumination variations in the scene. The tracker is initialized in a semi-manual manner by positioning the tool in the center of the ROI.

### Experiments and Results

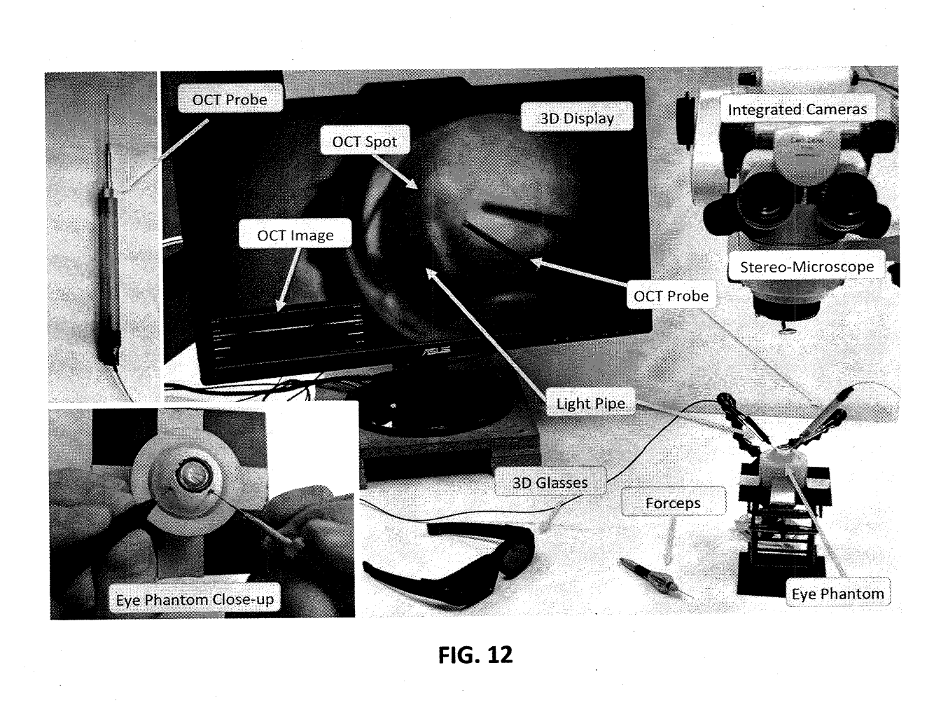

To evaluate the overall tracking performance we developed realistic water filled eyeball (25 mm ID) phantom. The sclera is cast out of soft silicone rubber (1 mm thick near the lens), with an O-Ring opening to accept a surgical contact lens to simulate typical visual access, see FIG. 12. Two surgical trocars are used for tool access. The visual field of view is ˜35 degrees considering a 5 mm iris opening, which is comparable to that of a surgical case where ˜20-45 degree vitreoretinal contact lenses are used. The eye rests in a plastic cup filled with methyl cellulose jelly to facilitate rotation. A thin, multi-layer latex insert, with hand painted vascular patterns, approximates the retina. These vascular details are coarser than those found in the human retina, but are still sufficient for tracking development, although not as good as the human retina's finer textures. Qualitative assessment by experienced vitreoretinal surgeons verified the ability of the model to simulate realistic eye behavior in surgical conditions. For independently verifiable ground truth ERM model, we chose a ˜1 mm sliver of yellow, 60 μm thick, polyester insulation tape, which was adhered to the surface of the retina. It is clearly visible in the video images and its OCT image shows high reflectivity in comparison with the less intense latex background layers.

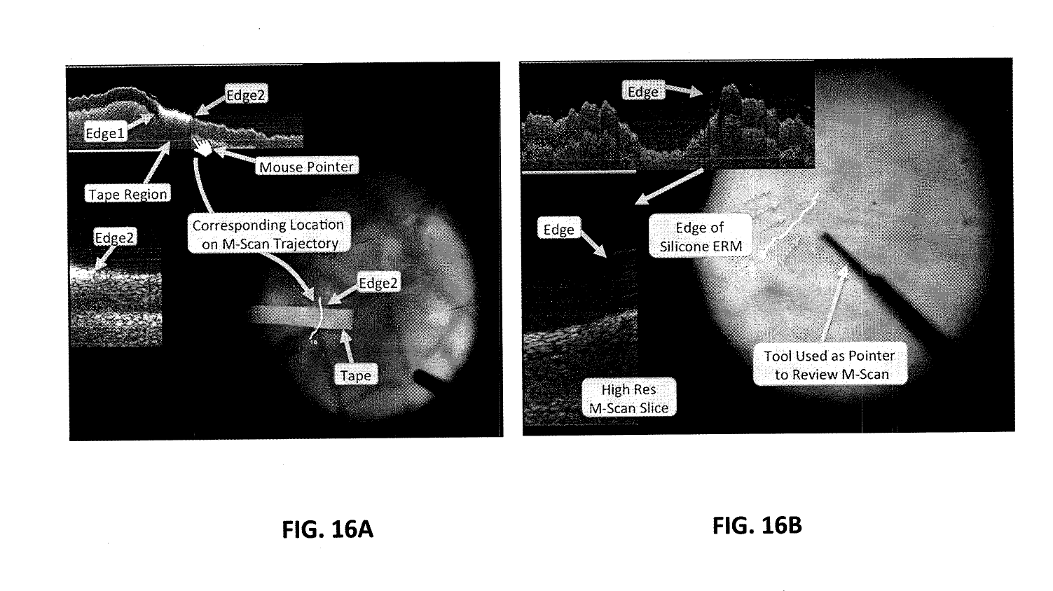

To assess the overall accuracy of the system, 15 M-Scans were performed in the following manner: The area near the tape was first explored by translating the eye to build an internal map of the retina. Then, the OCT probe was inserted into the eye and an M-Scan was performed with a trajectory shown in FIG. 16A. The location of the edges of the tape was explored using a mouse pointer on the OCT image. The corresponding A-Scan location was automatically highlighted on the scan trajectory. The captured video of the display was then manually processed to extract the pixel location of the tape edge for comparison with the location inferred from the M-Scan. The average overall localization error, which includes retina and OCT tracking, was 5.16±5.14 px for the 30 edges analyzed. Considering an average zoom level in this experiment, this error is equivalent to ˜100 μm, using the tape width (˜55 px) as a reference. Largest errors were observed when the scan position was far from the retina map origin. This is mainly due to the planar approximation model map, as well as distortions caused by the lens periphery. With higher magnifications this error is expected to decrease.

To independently validate the OCT tracker, 100 image frames were randomly chosen from the experimental videos. The position of the OCT projection was manually segmented in each frame and compared to the OCT tracking algorithm results, producing an average error of 2.2±1.74 px. Sources of this error can be attributed to manual segmentation variability, as well as OCT projection occlusions by the tool tip when the tool was closer than ˜500 μm to the retina.

Additionally, for the purpose of demonstration a thin layer of pure silicone adhesive was placed on the surface of the retina to simulate a scenario where an ERM is difficult to visualize directly. FIG. 16B shows the enface image of the invisible membrane and the corresponding M-Scan disclosing its cross-sectional structure. The surgeon can use the M-Scan functionality to determine the extents of the ERM and use the edge location to begin peeling.

### Discussion

In this example we presented a prototype for intraocular localization and assessment of retinal anatomy by combining visual tracking and OCT imaging. The surgeon may use this functionality to locate peeling targets, as well as monitor the peeling process for detecting complications and assessing completeness, potentially reducing the risk of permanent retinal damage associated with membrane peeling. The system can be easily extended to include other intraocular sensing instruments (e.g. force), can be used in the monitoring of procedures (e.g. laser ablation), and can incorporate preoperative imaging and planning. The methods are also applicable to other displays such as direct image injection into the microscope viewer presented in [14].

Our system can help a surgeon to identify targets, found in the OCT image, on the surface of the retina with the accuracy of ˜100±100 μm. This can easily be improved by increasing microscope magnification level or by using higher power contact lens. These accuracy values are within the functional range for a peeling application where the lateral size of target structures, such as ERM cavities, can be hundreds of microns wide, and the surgeons are approaching their physiological limits of precise freehand micro-manipulation [15]. We found that the retina tracking is the dominant component (˜60%) of the overall tracking error due to high optical distortions and the use of the planar retina model. Since the retinal model does not account for retinal curvature, the background tracker is only reliable when the translations of the retina are smaller than ⅓ of the ROI size. Furthermore, preliminary in-vivo experiments on rabbits are very encouraging, showing similar tracker behavior as in the eye phantom. Additionally, the system does not include registration between tracking sessions, i.e. when the light is turned on and off.

### REFERENCES FOR EXAMPLE 2

1. Wilkins, JR. et al, “Characterization of epiretinal membranes using optical coherence tomography”, Ophthalmology. 1996 December; 1 03(12):2142-51.
2. Hirano, Y. et al, “Optical coherence tomography guided peeling of macular epiretinal membrane”, Clinical Ophthalmology 2011:5 27-29
3. Ehlers, JP et al, “Integration of a Spectral Domain Optical Coherence Tomography System into a Surgical Microscope for Intraoperative Imaging”, IOVS May 2011 52:3153-3159;
4. Fleming, Ind. et al, “Intraoperative Visualization of Anatomical Targets in Retinal Surgery,” IEEE Workshop on Applications of Computer Vision, 2008. WAC 2008, pp. 1-6.
5. Han, S et al. “Handheld forward-imaging needle endoscope for ophthalmic optical coherence tomography inspection”, J. Biomed, Opt. 13, 020505 (Apr. 21, 2008);
6. Balicki, Mass. et al, “Single Fiber Optical Coherence Tomography Microsurgical Instruments for Computer and Robot-Assisted Retinal Surgery”, MICCAI '09
7. Mountney, P et al. “Optical Biopsy Mapping for Minimally Invasive Cancer Screening.” MICCAI 2009, pp. 483-490
8. Yamamoto, T. et al, “Tissue property estimation and graphical display for teleoperated robot-assisted surgery”, ICRA'09. pp. 4239-4245, May 2009
9. Atasoy, S et al “Endoscopic Video Manifolds for Targeted Optical Biopsy”, IEEE Transactions on Medical Imaging, November, 2011.
10. cisst-saw libraries: https://trac.lcsr.jhu.edu/cisst
11. X. Liu, M. Balicki, R. H. Taylor, and J. U. Kang, “Towards automatic calibration of Fourier-Domain OCT for robot-assisted vitreoretinal surgery,” Opt. Express 18, 24331-24343 (2010)
12. X. Liu and J. U. Kang, “Progress toward inexpensive endoscopic high-resolution common-path OCT”, Proc. SPIE 7559, 755902 (2010);
13. Richa, R et al, “Visual Tracking of Surgical Tools for Proximity Detection in Retinal Surgery”, In IPCAI 2011, vol. 6689, pp. 55-66.
14. Berger J W et al, “Augmented Reality Fundus Biomicroscopy”. Arch Ophthalmol/Vol 119, DEC 2011.
15. Riviere and P. S. Jensen, “A study of instrument motion in retinal microsurgery,” in Proc. Int. Conf. IEEE Engineering in Medicine and Biology Society, 2000, pp. 59-60.

The embodiments illustrated and discussed in this specification are intended only to teach those skilled in the art how to make and use the invention. In describing embodiments of the invention, specific terminology is employed for the sake of clarity. However, the invention is not intended to be limited to the specific terminology so selected. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

We claim:

1. An augmented field of view imaging system, comprising:
a microscope;
an image sensor system arranged to receive images of a plurality of fields of view from said microscope as at least one of said microscope and an object is moved relative to each other as said object is being viewed and to provide corresponding image signals;
an image processing and data storage system configured to communicate with said image sensor system to receive said image signals and to provide augmented image signals; and
at least one of an image injection system or an image display system configured to communicate with said image processing and data storage system to receive said augmented image signals and display an augmented field of view image,
wherein said image processing and data storage system is configured to track said plurality of fields of view in real time and register said plurality of fields of view to calculate a mosaic image, and
wherein said augmented image signals from said image processing and data storage system provide said augmented image such that a live field of view from said microscope is composited with said mosaic image.

2. An augmented field of view imaging system according to claim 1, wherein said live field of view from said microscope is visually distinguishable from said composited mosaic image.

3. An augmented field of view imaging system according to claim 2, wherein said live field of view from said microscope is a color image and said mosaic image is a gray-scale image.

4. An augmented field of view imaging system according to claim 2, wherein said image processing and data storage system is further configured to determine a location, a size and a shape of a pupil corresponding to said live field of view.

5. An augmented field of view imaging system according to claim 4, wherein said image processing and data storage system is further configured to blend pixels along an interface between said live field of view and said mosaic image.

6. An augmented field of view imaging system according to claim 4, wherein said image processing and data storage system is further configured to determine a background mask that labels each pixel in said augmented image as belonging to one of an unobserved region or an observed region for forming said augmented image.

7. An augmented field of view imaging system according to claim 6, wherein said background mask is opaque for unobserved regions of said augmented image and transparent for previously observed and live regions of said augmented image.

8. An augmented field of view imaging system according to claim 1, further comprising a touchscreen display configured to communicate with said image processing and data storage system to receive said augmented image signals,
wherein said image processing and data storage system is further configured to receive input from said touchscreen display and to display information as part of said augmented image based on said input from said touchscreen display.

9. An augmented field of view imaging system according to claim 8, wherein said input from said touchscreen display is an annotation on a displayed augmented image, and
wherein said image processing and data storage system is further configured to register said annotation to said displayed augmented image and to track said annotation in real time.

10. An augmented field of view imaging system according to claim 1, wherein said image processing and data storage system is configured to track said plurality of fields of view in real time using a Sum of Conditional Variances metric for evaluating image similarity in an iterative gradient descent framework.

11. An augmented field of view imaging system according to claim 1, wherein said image processing and data storage system is configured to track said plurality of fields of view in real time using a normalized cross-correlation method with multi-scale template matching.

12. An augmented field of view imaging system according to claim 1, further comprising a light source configured to illuminate an eye of a subject under observation with a sheet of light such that said augmented field of view imaging system is an augmented field of view slit lamp system.
